(19) United States
(12) Patent Application Publication
(10) Pub. No.: US 2014/0350919 A1
(43) Pub. Date: Nov. 27, 2014

(54) METHOD AND APPARATUS FOR WORD COUNTING

(71) Applicant: Tencent Technology (Shenzhen) Company Limited, Shenzhen (CN)

(72) Inventor: Feng ZHU, Shenzhen (CN)

(73) Assignee: Tencent Technology (Shenzhen) Company Limited, Shenzhen (CN)

(21) Appl. No.: 14/245,274

(22) Filed: Apr. 4, 2014

Related U.S. Application Data
(63) Continuation of application No. PCT/CN2013/088853, filed on Dec. 9, 2013.

(30) Foreign Application Priority Data
May 27, 2013 (CN) 201310200348.0

(51) Int. Cl. G06F 17/21

(52) U.S. Cl. CPC G06F 17/21
USPC 704/9

(57) ABSTRACT

A method for word counting is described, including: obtaining initial letter combinations for word combinations in a target text, wherein there is a one-to-one correspondence relationship between the initial letter combinations and the word combinations; counting occurrence frequencies of the initial letter combinations, and determining one or more initial letter combinations as target initial letter combinations; and determining target word combinations, each of which corresponding to a respective one of the target initial letter combinations according to the one-to-one correspondence relationship between the word combinations and the initial letter combinations, wherein occurrence frequency of a target initial letter combination serves as an occurrence frequency of corresponding target word combination. Further, an apparatus for word counting is described. In the method and the apparatus, memory consumption of device can be reduced in the process of counting occurrence frequencies of words.

### CROSS REFERENCE TO RELATED APPLICATIONS

This application is a U.S. continuation application under U.S.C. §111(a) claiming priority under U.S.C. §§120 and 365(c) to International Application No. PCT/CN2013/088853, filed on Dec. 9, 2013, which claims the priority benefit of Chinese Patent Application No. 201310200348.0, entitled “METHOD AND APPARATUS FOR WORD COUNTING” and filed on May 27, 2013, the content of which is hereby incorporated in its entire by reference.

### FIELD OF THE TECHNICAL

The disclosure relates to technical field of word processing, and in particular, to a method and an apparatus for word counting.

### BACKGROUND

This section provides background information related to the present disclosure which is not necessarily prior art.

Extraction of high frequency words is widely used nowadays. For example, words having highest frequency of occurrence in a text are selected as key words of the text. Currently, texts are analyzed mainly by using single Chinese words as units to count occurrence frequencies of words in the text. In such technology, all of two successive Chinese words are stored. If the number of Chinese words in an article is M, in extreme cases, there will be M−1 combinations. The number of combinations will increase with the increasing of the number of words, which causes memory consumption to rise.

### SUMMARY

Exemplary embodiments of the present invention provide a method and an apparatus for word counting, which can reduce memory consumption of devices during the process of counting occurrence frequencies of words.

One embodiment of the present invention provides a method for word counting, comprising: obtaining initial letter combinations for word combinations in a target text, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination; counting occurrence frequencies of the initial letter combinations, and determining one or more initial letter combinations as target initial letter combinations; and determining target word combinations, each of which corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination.

Another embodiment of the present invention provides an apparatus for word counting, comprising: an obtaining unit, which is configured to obtain initial letter combinations for word combinations in a target text, wherein there is a one-to-one correspondence relationship between the initial letter combinations and the word combinations, a word combination is a combination of at least one successive word, an initial letter combination the word combination is a combination of initial letters, and each of the initial letters is an initial letter of a phonetic notation of a respective one of all words in the word combination; a counting unit, which is configured to count occurrence frequencies of the initial letter combinations, and determine one or more initial letter combinations as target initial letter combinations; and a searching unit, which is configured to determine target word combinations, each of the searching unit corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination.

In the above technical solutions, initial letter combinations for word combinations in a target text are obtained, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination. Occurrence frequencies of the initial letter combinations are counted, and one or more initial letter combinations as target initial letter combinations are determined. Target word combinations are determined, and each of the target word combinations corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination. In this way, it is only needed to store initial letter combinations for words in the process of counting occurrence frequencies of words. There are only 23 letters in all initial letters of frequently used 3755 Chinese words. Since a combination of phonetic notations (Pinyin) can correspond to more than one combination of Chinese words, the combinations of initial letters of phonetic notations that actually occur in a article having M Chinese words will be far fewer than the combinations of Chinese words in the same article. Thus, memory consumption can be reduced.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a method for word counting according to one embodiment of the present invention;

FIG. 2 is a flowchart of one method for word counting according to another embodiment of the present invention;

FIG. 3 is a schematic diagram of an apparatus for word counting according to yet another embodiment of the present invention;

FIG. 4 is a schematic diagram of an apparatus for word counting according to yet another embodiment of the present invention.

### DETAILED DESCRIPTION OF ILLUSTRATED EMBODIMENTS

In order to make technical solutions of the present invention more apparent, the present invention will be described clearly and completely hereinafter with reference to accompanying drawings in embodiments of the present invention. It is apparent that the embodiments described hereafter are only part of the embodiments of the present invention, but not all of the embodiments. On the basis of the embodiments of the present invention, other embodiments obtained by an ordinary skilled in the art of the present invention without creative work are protected by the present invention.

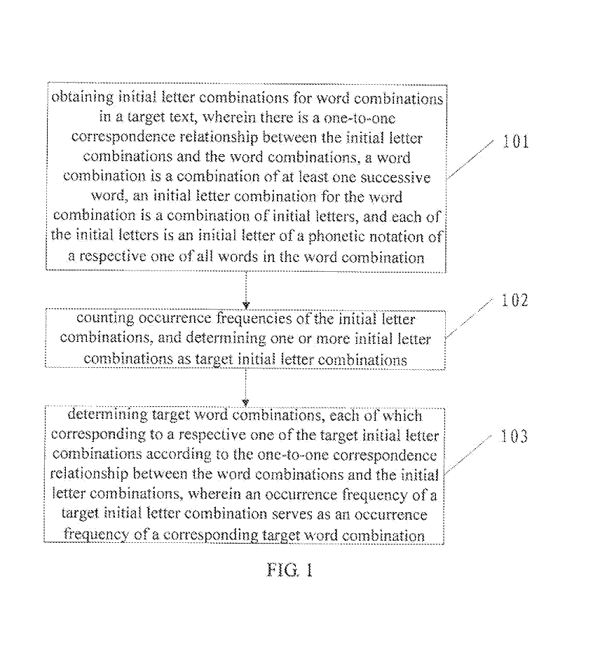

FIG. 1 is a flowchart of a method for word counting according to one embodiment of the present invention. As shown in FIG. 1, the method may comprise the following steps.

Step 101 is: obtaining initial letter combinations for word combinations in a target text, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination.

The word combination refers to a combination of at least one successive word; namely, a word combination may contain one or more words. For example, word combinations, such as “ [symbol] ”, “ [symbol] ”, “ [symbol] ”, etc, are contained in the target text, and these word combinations respectively correspond to initial letter combinations of “6H”, “WL” and “JSJ”. It is certain that initial letter combinations for word combinations that have a specific attribute in the target text may also be obtained in the embodiment, tier example, what is obtained in a target text may be initial letter combinations for word combinations of nouns, or initial letter combinations for word combinations of verbs in the embodiment. That is, the above word combinations may be nouns or verbs. The specific attribute of word combinations may be set according to user's needs, such as: noun, verb, adjective, etc.

Step 102 is: counting occurrence frequencies of the initial letter combinations, and determining one or more initial letter combinations as target initial letter combinations.

The target initial letter combination may be one or more initial letter combinations that have highest frequency of occurrence in initial letter combinations obtained in step 101; may be one or more pre-assigned initial letter combinations in initial letter combinations obtained in step 101; or may be initial letter combinations for one or more pre-assigned word combinations in initial letter combinations obtained in step 101.

Step 103 is: determining target word combinations, each of which corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination.

Optionally, the above target text may be any texts stored in computers, mobile phones, tablet PCs, servers, or virtual networks. Common examples today include comments, microbloggings, etc.

Optionally, the method may be used in any devices that are capable of dealing with texts, such as computers, mobile phones, tablet PCs, servers, virtual networks. That is, the method may be performed in any of these devices.

For example, illustration will be provided taking a text “ [symbol] [symbol] [symbol] , [symbol] [symbol] , [symbol] [symbol] ” as an example. Suppose that the above-mentioned word combination is a combination of two successive words, and one initial letter combination of highest occurrence frequency in initial letter combinations obtained in step 101 is determined as the target initial letter combination. So, the text have word combinations of “ [symbol] ”, [symbol] [symbol] ”, “ [symbol] ”, “ [symbol] ”, . . . , “ [symbol] ”, “ [symbol] ”, “ [symbol] ”, wherein the initial letter combination of “ [symbol] ” is WL. Here, initial letter combinations for other word combinations will not be enumerated. In the implementation of counting in step 102, it can be determined that the target initial letter combination is WL in step 102. In step 103, the target word combination for WL is searched for in the target text, namely, “ [symbol] ” is obtained. So, “ [symbol] ” has the highest occurrence frequency in the text, and occurrence frequency of this combination may be counted.

In the above technical solutions, initial letter combinations for word combinations in a target text are obtained, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination. Occurrence frequencies of the initial letter combinations are counted, and one or more initial letter combinations as target initial letter combinations are determined. Target word combinations are determined, and each of the target word combinations corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination. In this way, it is only needed to store initial letter combinations for words in the process of counting occurrence frequencies of words. There are only 23 letters in all initial letters of frequently used 3755 Chinese words. Since a combination of phonetic notations (Pinyin) can correspond to more than one combination of Chinese words, the combinations of initial letters of phonetic notations that actually occur in a article having M Chinese words will be far fewer than the combinations of Chinese words in the same article. Thus, memory consumption can be reduced.

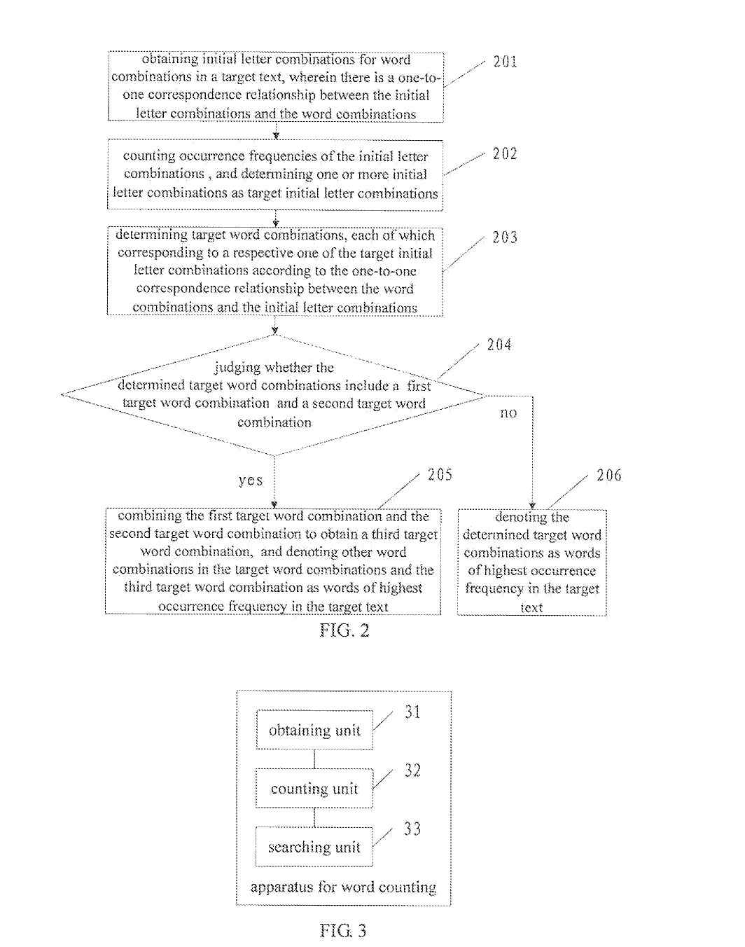

FIG. 2 is a flowchart of a method for word counting according to another embodiment of the present invention. As shown in FIG. 2, the method may comprise the following steps.

Step 201 is: obtaining initial letter combinations for word combinations in a target text, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination.

Optionally, in step 201, each word in the target text may be converted into Pinyin, and then the words are combined to obtain initial letter combinations for each word combination.

Optionally, since American Standard Code for Information Interchange (Ascii) of words is sorted based on Pinyin, so Pinyin of each word may be obtained according to Ascii of the word in step 201.

Step 202 is: counting occurrence frequencies of the initial letter combinations, and determining one or more initial letter combinations as target initial letter combinations.

Optionally, in step 202, occurrence frequencies of all initial letter combinations obtained in step 201 may be sorted, and initial letter combinations of highest occurrence frequency are selected as target initial letter combinations, wherein H is an integer greater than zero.

Step 203 is: determining target word combinations, each of which corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination.

Optionally, in step 203, word combinations corresponding to each target initial letter combinations may all be selected. Then, occurrence frequencies of word combinations corresponding to each target initial letter combination may be sorted, and target word combinations corresponding to each target initial letter combination may be selected in step 203. For example, word combinations whose initial letter combination is the target initial letter combination 1 may include: word combination 1, word combination 2, and word combination 3, wherein occurrence frequency of the word combination 1 is the highest. So the word combination 1 will be the target word combination for the target initial letter combination 1.

Step 204 is: judging whether the determined target word combinations include a first target word combination and a second target word combination, wherein the last word of the first target word combination is identical with the initial word of the second target word combination; if the determined target word combinations include the first target word combination and the second target word combination, performing step 205; if the determined target word combinations do not include both of the first target word combination and the second target word combination, performing step 206.

Step 205 is: combining the first target word combination and the second target word combination to obtain a third target word combination, and denoting other word combinations in the target word combinations and the third target word combination as words of highest occurrence frequency in the target text, wherein the other word combinations are all of the target word combinations except for the first target word combination and the second target word combination.

Optionally, for example, the word of the highest occurrence frequency in the target text is “ [symbol] ”, and the word combination above is defined as a combination of two successive words. So, target word combinations determined in step 203 are “ [symbol] ” and “ [symbol] ”, wherein “ [symbol] ” is determined as a first target word combination in step 204, and “ [symbol] ” is determined as a second target word combination in step 204. These two word combinations may be combined in step 205 to obtain a third target word combination “ [symbol] ”. For another example, “ [symbol] ” is the word of highest occurrence frequency in the target text, the word combination above is defined as a combination of three successive words, so the target word combinations determined in step 203 are “ [symbol] ” and “ [symbol] ”, wherein “ [symbol] ” is determined as a first target word combination in step 204, and “ [symbol] ” is determined as a second target word combination in step 204. These two word combination may be combined in step 205 to obtain a third target word combination “ [symbol] ”.

Step 206 is: denoting the determined target word combinations as words of highest occurrence frequency in the target text.

As an alternative embodiment, in step 205, combining the first target word combination and the second target word combination to obtain a third target word combination may comprise:

combining the first target word combination and the second target word combination to obtain a candidate target word combination; judging whether the target text includes the candidate target word combination, if the target text includes the candidate target word combination, denoting the candidate target word combination as a third target word combination; and if the target text does not include the candidate target word combination, discarding the candidate target word combination, and triggering step 206.

For example, it the word combination is defined as a combination of two successive words, the target word combinations determined in step 203 are “ [symbol] ” and “ [symbol] ”, wherein “ [symbol] ” is determined as a first target word combination, in step 204, and “ [symbol] ” is determined as a second target word combination in step 204. These two word combinations may be combined in step 205 to obtain a candidate target word combination “ [symbol] ”. Since there is the word combination of “ [symbol] ” in the target text, “ [symbol] ” is denoted as a third target word combination. For another example, if the word combination is defined as a combination of two successive words, the target word combinations determined in step 203 are “ [symbol] ” and “ [symbol] ”, wherein “ [symbol] ” is determined as a first target word combination in step 204, and “ [symbol] ” is determined as a second target word combination in step 204. These two word combinations may be combined in step 205 to obtain a candidate target word combination “ [symbol] ”. However, since there is not the word combination of “ [symbol] ” in the target text, the candidate target word combination will be discarded.

As an alternative embodiment, in step 205, combining the first target word combination and the second target word combination to obtain a third target word combination may comprise:

judging whether an occurrence frequency of the first target word combination is identical with an occurrence frequency of the second target word combination in the target text, and if the occurrence frequency of the first target word combination is identical with the occurrence frequency of the second target word combination in the target text, combining the first target word combination and the second target word combination to obtain a third target word combination.

Optionally, if the occurrence frequency of the first target word combination is not identical with the occurrence frequency of the second target word combination in the target text, step 206 is triggered.

As an alternative embodiment, in step 205, combining the first target word combination and the second target word combination to obtain a third target word combination may comprise:

judging whether an occurrence frequency of the first target word combination is identical with an occurrence frequency of the second target word combination in the target text, and if the occurrence frequency of the first target word combination is identical with the occurrence frequency of the second target word combination in the target text, combining the first target word combination and the second target word combination to obtain a candidate target word combination; judging whether the target text includes the candidate target word combination, if the target text includes the candidate target word combination, denoting the candidate target word combination as a third target word combination; and if the target text does not include the candidate target word combination, discarding the candidate target word combination, and triggering step 206.

If the occurrence frequency of the first target word combination is not identical with the occurrence frequency of the second target word combination in the target text, step 206 is triggered.

In the above technical solutions, more methods for determining words can be achieved on the basis of the embodiment mentioned before them, and memory consumption can be reduced in all of these methods.

Below is apparatus embodiments of the present invention, wherein the apparatus embodiments of the present invention are configured to perform the methods in the first and second embodiments of the present invention. In order for convenient illustration, in apparatus embodiments of the present invention, only those relevant with embodiments of the present invention are described, and for technology details that are not described, one may refer to the first and second embodiments of the present invention.

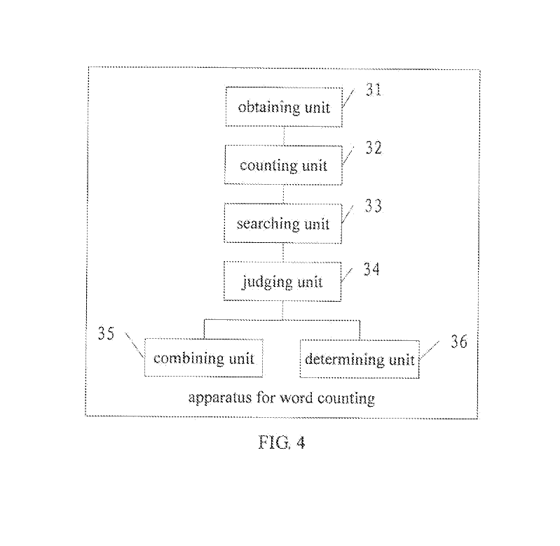

FIG. 3 is a schematic diagram of an apparatus for word counting according to yet another embodiment of the present invention. As shown in FIG. 3, the apparatus may comprise: an obtaining unit 31, a counting unit 32 and a searching unit 33.

The obtaining unit 31 is configured to obtain initial letter combinations for word combinations in a target text, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination.

The word combination refers to a combination of at least one successive word; namely, a word combination may contain one or more words. For example, word combinations, such as “ [symbol] ”, “ [symbol] ”, “ [symbol] ”, etc, are contained in the target text, and these word combinations respectively correspond to initial letter combinations of “6H”, “WL” and “JSJ”. It is certain that initial letter combinations for word combinations that have a specific attribute in the target text may also be obtained in the embodiment, for example, what is obtained in a target text may be initial letter combinations for word combinations of nouns, or initial letter combinations for word combinations of verbs in the embodiment. That is, the above word combinations may be nouns or verbs. The specific attribute of word combinations may be set according to user's needs, such as: noun, verb, adjective. etc.

The counting unit 32 is configured to count occurrence frequencies of the initial letter combinations, and determine one or more initial letter combinations as target initial letter combinations.

The target initial letter combination may be one or more initial letter combinations that have highest frequency of occurrence in initial letter combinations obtained by the obtaining unit 31; may be one or more pre-assigned initial letter combinations in initial letter combinations obtained by the obtaining unit 31; or may be initial letter combinations for one or more pre-assigned word combinations in initial letter combinations obtained by the obtaining unit 31.

The searching unit 33 is configured to determine target word combinations, each of the searching unit corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination.

Optionally, the above target text may be any texts stored in computers, mobile phones, tablet PCs, servers, or virtual networks. Common examples today include comments, microbloggings, etc.

Optionally, said device may be any device that is capable of dealing with texts, such as computers, mobile phones, tablet PCs, servers, virtual networks.

As an alternative embodiment, as shown in FIG. 4, the apparatus may further comprise: a judging unit 34, a combining unit 35, and a determining unit 36.

The judging unit 34 is configured to judge whether the determined target word combinations include a first target word combination and a second target word combination, wherein the last word of the first target word combination is identical with the initial word of the second target word combination.

The combining unit 35 is configured to, when the result of the judging unit 34 is yes, combine the first target word combination and the second target word combination to obtain a third target word combination, and denote other word combinations in the target word combinations and the third target word combination as words of highest occurrence frequency in the target text; wherein the other word combinations are all of the target word combinations except for the first target word combination and the second target word combination.

The determining unit 36 is configured to, when the result of the judging unit 34 is no, denote the determined target word combinations as words of highest occurrence frequency in the target text.

Optionally, the combining unit 35 may be further configured to combine the first target word combination and the second target word combination to obtain a candidate target word combination; judge whether the target text includes the candidate target word combination; if the target text includes the candidate target word combination, denote the candidate target word combination as a third target word combination; and if the target text does not include the candidate target word combination, discard the candidate target word combination.

Optionally, the combining unit 35 may be further configured to judge whether an occurrence frequency of the first target word combination is identical with an occurrence frequency of the second target word combination in the target text; and if the occurrence frequency of the first target word combination is identical with the occurrence frequency of the second target word combination in the target text, combine the first target word combination and the second target word combination to obtain a third target word combination.

Optionally, the combining unit 35 may be further configured to judge whether an occurrence frequency of the first target word combination is identical with an occurrence frequency of the second target word combination in the target text; if the occurrence frequency of the first target word combination is identical with the occurrence frequency of the second target word combination in the target text, combine the first target word combination and the second target word combination to obtain a candidate target word combination; judge whether the target text includes the candidate target word combination; if the target text includes the candidate target word combination, denote the candidate target word combination as a third target word combination; and if the target text does not include the candidate target word combination, discard the candidate target word combination.

The determining unit 36 is configured to denote the determined target word combinations as words of most occurrence frequency in the target text when the combining unit 35 judges that the occurrence frequency of the first target word combination is not identical with the occurrence frequency of the second target word combination in the target text.

In the above technical solutions, initial letter combinations for word combinations in a target text are obtained, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination. Occurrence frequencies of the initial letter combinations are counted, and one or more initial letter combinations as target initial letter combinations are determined. Target word combinations are determined, and each of the target word combinations corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination. In this way, it is only needed to store initial letter combinations for words in the process of counting occurrence frequencies of words. There are only 23 letters in all initial letters of frequently used 3755 Chinese words. Since a combination of phonetic notations (Pinyin) can correspond to more than one combination of Chinese words, the combinations of initial letters of phonetic notations that actually occur in a article having M Chinese words will be far fewer than the combinations of Chinese words in the same article. Thus, memory consumption can be reduced.

Those skilled in the art can understand that whole or parts of the process in the above-described embodiments can be implemented by controlling relevant hardware using computer programs. The computer programs may be stored in computer-readable storage media. During the program execution, the program may carry out the processes described in the embodiments. Further, the storage media may be a magnetic disk, optical disk, read-only storage memory (ROM), random access memory (RAM), etc.

The foregoing descriptions are merely exemplary embodiments of the present invention, but not intended to limit the protection scope of the present invention. Any variation made by persons of ordinary skills in the at without departing from the spirit of the present invention shall fall within the protection scope of the present invention.

1. A method for word counting, comprising, the steps of:
obtaining initial letter combinations for word combinations in a target text, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination;
counting occurrence frequencies of the initial letter combinations, and determining one or more initial letter combinations as target initial letter combinations; and
determining target word combinations, each of which corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination.

2. The method as claimed in claim 1, after the step of determining target word combinations, each of which corresponding to a respective one of the target initial letter combinations, further comprising:
judging whether the determined target word combinations include a first target word combination and a second target word combination, wherein the last word of the first target word combination is identical with the initial word of the second target word combination;
if the determined target word combinations include the first target word combination and the second target word combination, combining the first target word combination and the second target word combination to obtain a third target word combination, and denoting other word combinations in the target word combinations and the third target word combination as words of highest occurrence frequency in the target text, wherein the other word combinations are all of the target word combinations except for the first target word combination and the second target word combination; and
if the determined target word combinations do not include both of the first target word combination and the second target word combination, denoting the determined target word combinations as words of highest occurrence frequency in the target text.

3. The method as claimed in claim 2, wherein the step of combining the first target word combination and the second target word combination to obtain a third target word combination comprises:
combining the first word combination and the second target word combination to obtain a candidate target word combination; and
judging whether the target text includes the candidate target word combination, if the target text includes the candidate target word combination, denoting the candidate target word combination as a third target word combination; and if the target text does not include the candidate target word combination, discarding the candidate target word combination.

4. The method as claimed in claim 2, wherein the step of combining the first target word combination and the second target word combination to obtain a third target word combination, comprises:
judging whether an occurrence frequency of the first target word combination is identical with an occurrence frequency of the second target word combination in the target text, and if the occurrence frequency of the first target word combination is identical with the occurrence frequency of the second target wore combination in the target text, combining the first target word combination and the second target word combination to obtain a third target word combination.

5. The method as claimed in claim 1, wherein the step of obtaining initial letter combinations for word combinations in a target text comprises:
obtaining the initial letter combinations for the word combinations that have a specific attribute in the target text.

6. An apparatus for word counting, comprising:
an obtaining unit, which is configured to obtain initial letter combinations for word combinations in a target text, wherein there is a one-to-one correspondence relationship between the initial letter combinations and the word combinations, a word combination is a combination of at least one successive word, an initial letter combination for the word combination is a combination of initial letters, and each, of the initial letters is an initial letter of a phonetic notation of a respective one of all words in the word combination;
a counting unit, which is configured to count occurrence frequencies of the initial letter combinations, and determine one or more initial letter combinations as target initial letter combinations; and
a searching unit, which is configured to determine target word combinations, each of the searching unit corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination.

7. The apparatus as claimed in claim 6, further comprising:
a judging unit, which is configured to judge whether the determined target word combinations include a first target word combination and a second target word combination, wherein the last word of the first target word combination is identical with the initial word of the second target word combination;
a combining unit, which is configured to, if the determined target word combinations include the first target word combination and the second target word combination, combine the first target word combination and the second target word combination to obtain a third target word combination, and denote other word combinations in the target word combinations and the third target word combination as words of highest occurrence frequency in the target text; wherein the other word combinations are all of the target word combinations except for the first target word combination and the second target word combination, and
a determining unit, which is configured to, if the determined target word combinations do not include bother of the first target word combination and the second target word combination, denote the determined target word combinations as words of highest occurrence frequency in the target text.

8. The apparatus as claimed in claim 7, wherein the combining unit is further configured to combine the first target word combination and the second target word combination to obtain a candidate target word combination; judge whether the target text includes the candidate target word combination, if the target text includes the candidate target word combination, denote the candidate target word combination as a third target word combination, and if the target text does not include the candidate target word combination, discard the candidate target word combination.

9. The apparatus as claimed in claim 7, wherein the combining unit is further configured to judge whether an occurrence frequency of the first target word combination is identical with an occurrence frequency of the second target word combination in the target text, and if the occurrence frequency of the first target word combination is identical with the occurrence frequency of the second target word combination in the target text, combine the first target word combination and the second target word combination to obtain a third target word combination.

10. The apparatus as claimed in claim 6, wherein the obtaining unit is further configured to obtain the initial letter combinations for the word combinations that have a specific attribute in the target text.

11. The method as claimed in claim 2, wherein the step of obtaining initial letter combinations for word combinations in a target text comprises:
obtaining the initial letter combinations for the word combinations that have a specific attribute in the target text.

12. The method as claimed in claim 3, wherein the step of obtaining initial letter combinations for word combinations in a target text comprises:
obtaining the initial letter combinations for the word combinations that have a specific attribute in the target text.

13. The method as claimed in claim 4, wherein the step of obtaining initial letter combinations for word combinations in a target text comprises:
obtaining the initial letter combinations for the word combinations that have a specific attribute in the target text.

14. The apparatus as claimed in claim 7, wherein the obtaining unit is further configured to obtain the initial letter combinations for the word combinations that have a specific attribute in the target text.

15. The apparatus as claimed in claim 8, wherein the obtaining unit is further configured to obtain the initial letter combinations for the word combinations that have a specific attribute in the target text.

16. The apparatus as claimed in claim 9, wherein the obtaining unit is further configured to obtain the initial letter combinations for the word combinations that have a specific attribute in the target text.

17. A non-transitory computer readable storage medium, storing one or more programs for execution by one or more processors of a computer having a display, the one or more programs comprising instructions for:
obtaining initial letter combinations for word combinations in a target text, wherein there is a one-to-one correspondence relationship between the initial letter combinations and the word combinations, a word combination is a combination of at least one successive word, an initial letter combination for the word combination is a combination of initial letters, and each of the initial letters is an initial letter of a phonetic notation of a respective one of all words in the word combination;
counting occurrence frequencies of the initial letter combinations, and determining one or more initial letter combinations as target initial letter combinations; and
determining target word combinations, each of which corresponding to a respective one of the target initial letter combinations according to the one-to-one correspondence relationship between the word combinations and the initial letter combinations, wherein an occurrence frequency of a target initial letter combination serves as an occurrence frequency of a corresponding target word combination.
